(19) United States
(12) Patent Application Publication
(10) Pub. No.: US 2011/0048996 A1
(43) Pub. Date: Mar. 3, 2011

(54) MULTI-LAYER PACKAGING MATERIAL

(75) Inventors: Thomas Klaus, Wolfertschwenden (DE); Ulf Wienboeker, Weitnau-Hellengerst (DE)

(73) Assignee: Huhtamaki Ronsberg, Zweigniederlassung der Huhtamaki Deutschland GmbH, Ronsberg (DE)

(21) Appl. No.: 12/858,261

(22) Filed: Aug. 17, 2010

(30) Foreign Application Priority Data
Aug. 18, 2009 (DE) DE102009037862.6

(51) Int. Cl. B65D 3/06; B31B 1/00; B32B 3/30; B32B 15/12

(52) U.S. Cl. 206/459.5; 493/267; 428/172

(57) ABSTRACT

Multi-layer packaging material, especially laminate, preferably for food, hygiene products and electronic products, having at least one metal barrier—especially aluminum—layer and at least one paper layer, and also roll material. The paper layer is laser-marked with predetermined intensity at least portion-wise through its entire cross-section, and optionally the metal layer on its surface side.

### BACKGROUND OF THE INVENTION

1. Field of the Invention

The present invention relates to a multi-layer packaging material for food, having at least one metal barrier—especially aluminum—layer and paper layer, to a unit piece comprising such a packaging material, to a packaging produced therefrom, and to roll material, in accordance with the preambles of patent claims 1, 6, 7 and 8.

2. Description of the Related Art

Such packaging material is usually printed, the printing being carried out on the aluminum layer or, preferably, on the paper layer. In the case of somewhat more costly packagings, the printed paper layer is additionally surface-coated, externally laminated and/or sealed in order to make it substantially resistant to smudging and scratching.

When packagings produced from known packaging materials are stacked on top of one another or inside one another for the purpose of transportation, there is a risk that the printing will be transferred from the, usually, outside of the packaging onto the inside of the packaging, which comes into contact with food. Such transfer can present food hygiene problems and should be prevented as far as possible. It is accordingly important to prevent such transfer. This can be accomplished—as already mentioned—by means of costly sealing of the printed surface or by avoiding the use of printing ink as far as possible, which does however entail the disadvantage that such printing-ink-free packagings can only be marked by extremely costly means, for example with the aid of stickers.

### SUMMARY OF THE INVENTION

The problem underlying the present invention is to provide a packaging material of the kind mentioned at the beginning, especially also in the form of roll material and pre-cut material, which is cheap to produce and mark, that is to say to print as desired, without using printing ink. A further problem is to make available unit pieces produced from such a packaging material for producing ready-to-use packagings, and also such packagings themselves.

The problem in respect of the packaging material is solved by the characterising features of claim 1.

The problem according to the invention is solved especially by a multi-layer packaging material, especially a laminate, for food, having at least one metal barrier—especially aluminum—layer, and at least one paper layer, the paper layer being laser-marked with predetermined intensity at least portion-wise through its entire cross-section, and optionally the aluminum layer on its surface side.

A core aspect of the present invention accordingly lies in the fact that the printing is performed by means of a laser, or laser beam, the paper layer, which in the finished packaging defines the outer layer and/or inner layer, being—in accordance with the invention—laser-marked with predetermined intensity right through, that is to say at least portion-wise through its entire cross-section, and optionally the underlying aluminum layer on its surface side.

In this case, the packaging material, namely especially primarily the paper layer, is irradiated using at least one, preferably focussed, laser beam of predetermined intensity, so that the paper layer becomes oxidatively perforated, especially “burnt through”, whilst the underlying aluminum layer optionally becomes marked, for example discolored, to a greater or lesser degree as a result of the laser irradiation, as desired, depending on the intensity of the laser.

Depending on the focussing of the laser beam(s) it is possible, in accordance with the invention, to produce in the paper layer a channel-like perforation having substantially parallel, tapering or curved side walls, the fibrous materials of the paper layer consisting advantageously of 100% cellulose having a fineness of 30° SR.

Preference is moreover given to using paper having a weight of about 50 to 140 g/m².

In accordance with an embodiment of the invention, the paper layer contains amounts of micronized and/or fibrous plastic(s), especially linear aromatic polyesters and/or linear polyarylenes, and also, optionally, colored pigments, preferably light-sensitive pigments, the amount(s) thereof being in each case in the range between about 0.001 and 15% by weight, preferably in the range between about 0.008 and 5.3% by weight and especially in the range between about 0.05 and 0.09% by weight, based on the weight of the paper.

Insofar as such laser-radiation-absorbing plastics and/or carbon sources and also, optionally, colored pigments and also light-sensitive pigments are admixed with the paper of the paper layer, a printed image produced by means of laser marking can be obtained with the substantially entire color spectrum, if the particle size of the absorbents and carbon sources and also pigments, as provided in accordance with the invention, is about 0.005 to 150 μ, preferably about 0.05 to 150 μ.

Polycarbonate, polyethylene terephthalate, polyvinyl sulfide and/or a polyarylene ether are preferably used as plastics.

As a result of using plastics as a constituent of the paper layer it is advantageously possible to produce rounded-off and also, depending on the amount of plastics, fused perforation rims and edges.

In the case of a preferred embodiment having, for the paper layer, normal paper with a weight of 80 g/m², the paper and aluminum layers are laser-marked by means of a CO₂, solid-state or, especially, YAG laser having an energy density in the range from 0.3 mJ/cm² to 50 J/cm², especially about 0.5 mJ/cm² to 15 J/cm², or by means of a pulsed laser having a pulse frequency in the range from 0.1 to 10000 Hz, especially from 1 to 1000 Hz, and a pulse length in the range from 0.1 to 1000 ns, especially 1 to 100 ns, in each case in an atmospheric environment. The intensity of the laser, which usually has a power of about 0.1 W to 100 W, preferably 1 W to 55 W, and especially 5 W to 30 W, ultimately depends on the selected paper quality and also on the quality of the aluminum layer.

This kind of printing is extremely simple. It can be carried out in an atmospheric environment, the use of conventional lasers being sufficient to produce the packaging material according to the invention. For obtaining monochrome color effects and also a color palette in the range from light-yellow through brownish tones to virtually black, the paper layer can be produced from normal paper.

The present invention relates also to a unit piece of packaging material of the aforementioned kind for producing packagings, especially so-called “paper cones” for holding food, especially for holding complementarily shaped wafers to be filled with ice-cream at a later stage. When the laser marking is carried out on the outside of the paper cone, no ink can pass from that laser-marked outside to the inside of a paper cone, which comes into contact with the food, when the paper cones are stacked up inside one another, because the laser marking does not transfer. The same applies in the case of re-stacking paper cones into which empty (i.e. not yet filled with ice-cream) wafers have already been introduced. In accordance with the invention it is moreover also possible for printing to be provided on the inside of the paper cone.

The invention relates especially also to finished packagings made from a packaging material of the aforementioned kind, especially to paper cones, and also to roll material, especially for producing a paper cone for holding food, preferably for holding wafers to be filled with ice-cream, and especially also for producing a packaging for hygiene products, electronic products and animal feed, having at least one metal barrier—especially aluminum—layer and at least one paper layer, the paper layer being laser-marked with predetermined intensity at least portion-wise through its entire cross-section, and optionally the metal barrier —especially aluminum—layer on its surface side.

It should also be mentioned that the packaging material can comprise the following layers:
oriented polypropylene (OPP)/color/aluminum/paper; or
polyethylene terephthalate (PET)/color/aluminum/paper; or
oriented polypropylene (OPP)/paper/aluminum/paper; or
surface-coating/color/aluminum/paper; or
paper/aluminum/paper; or
paper/aluminum (simplest embodiment).

It has been pointed out hereinbefore that the paper layer can include absorbents and carbon sources. For these there are preferably used micronized plastics consisting of linear aromatic polyesters and/or linear polyarylenes having a particle size as mentioned hereinbefore.

Another aspect of the invention relates to a method of producing a packaging unit, comprising obtaining the multi-layer packaging material as described hereinabove and forming the material into a packaging unit. Either the inside and/or outside of the packaging unit is laser-marked. The packaging unit can be adapted for holding food, such as a paper cone for holding an ice-cream cone. Thus, a paper cone is one example of the packaging units that can be formed from the multi-layer packaging material that is described. This packaging material can also be rolled to form a roll.

### BRIEF DESCRIPTION OF THE DRAWINGS

A preferred embodiment of a packaging material according to the invention and a packaging produced therefrom (paper cone) will be explained in greater detail hereinbelow with reference to the accompanying drawings, in which

FIG. 1 is a section, to an enlarged scale, through a laser-marked packaging material consisting of paper/aluminum/paper;

FIG. 2 is a section, to an enlarged scale, through a laser-marked packaging material consisting of paper/aluminum; and

FIG. 3 is a perspective view of a paper cone produced from a packaging material according to FIG. 1.

### DETAILED DESCRIPTION OF THE PREFERRED EMBODIMENT

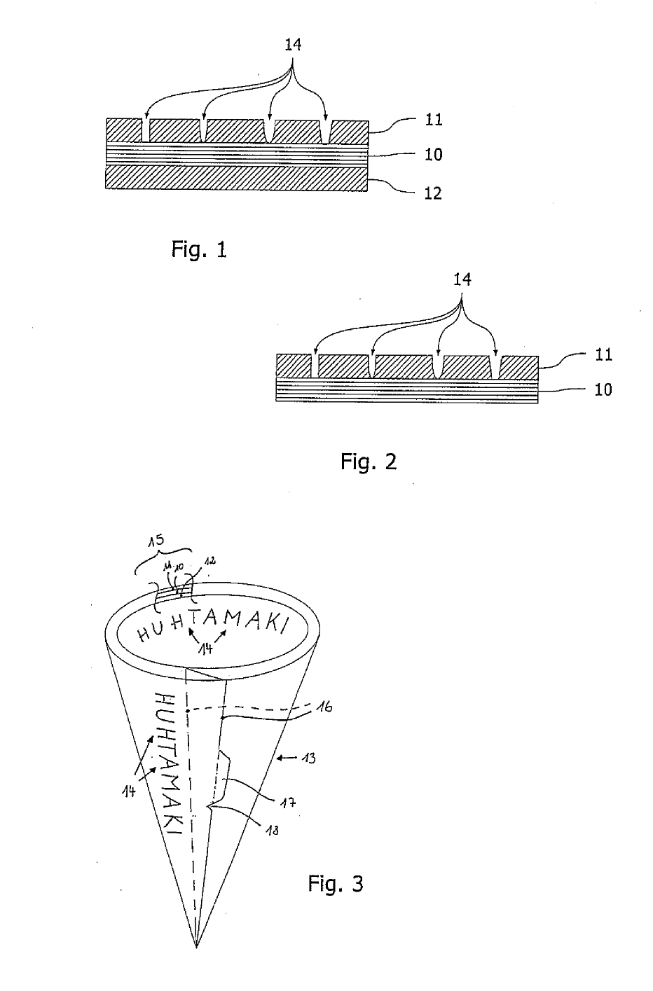

FIG. 1 shows, in an enlarged cross-section, part of a packaging material formed in accordance with the invention. This packaging material consists of three layers, namely an outer and an inner paper layer 11, 12 and a central aluminum layer 10. The outer paper layer 11 is laser-marked, these markings being indicated by reference numeral 14. It can be seen that, as a result of the laser marking, the outer paper layer 11 has been “burnt through” and the central aluminum layer 10 is laser-marked, that is to say exposed, only on its surface side. Depending on the intensity of the laser, especially the perforation edge of the paper layer is discolored to a greater or less extent, from light-yellow through gold to dark-brown, and is smoothly formed—to a greater extent in the case of greater laser beam intensity and focussing density and to a lesser extent in the case of lower laser beam intensity and focussing density. The color of the “printing” obtained by the laser marking that appears to the observer results from light reflection and light refraction at the edges of the perforation, on the one hand, and the aluminum foil or layer, on the other hand, and an overlayering of these effects.

If required, the opposite side of the packaging material can also, as previously mentioned, be laser-marked. Laser marking on both sides of the multi-layer packaging material is then obtained.

FIG. 2 shows a section through a laser-marked packaging material corresponding to FIG. 1 with the difference that, according to FIG. 2, only one paper layer 11 is provided on the aluminum layer 10, in which laser markings 14 in the form of continuous or interrupted perforations are introduced. The packaging material according to FIG. 2 is accordingly, in contrast to the packaging material according to FIG. 1, suitable not for two-sided but rather for one-sided marking, that is to say “printing”.

In FIG. 3, a so-called “paper cone” 13 has been produced from a packaging material according to the invention in accordance with FIG. 1. The cone is laser-marked (see reference numeral 14) both on the inside and on the outside. The packaging material consists of three layers, with the layer sequence paper/aluminum/paper, as can be seen from the portion 15 of paper cone material in FIG. 3. Having regard to the thickness of the packaging material, it should be noted that the individual layers have been exaggeratedly shown in FIG. 3. The overall thickness of the three-layer material for the paper cone 13 is max. about 0.08 to 0.5 mm. The thickness of each individual layer 10, 11, 12 is between 0.005 to max. 0.3 mm.

In the region of overlapping longitudinal edges 16 of the packaging material unit piece from which the paper cone according to FIG. 3 has been formed there is provided, on the outside, a gripping tab 17, by means of which the paper cone can be ripped open and removed from the contents of the packaging.

When paper cones 13 of the kind shown in FIG. 3 are stacked inside one another, especially for the purpose of transportation or also for the purpose of being made available for filling, there is no longer a risk that printing ink will be transferred from the outside of the paper cone onto the inside of the next paper cone placed on top of it or inside it.

For producing a paper cone according to FIG. 3, the unit piece of packaging material is approximately triangular, with the side which defines the circumferential edge of the paper cone defining an outwardly extending arc of a circle.

At the bottom end of the gripping tab 17 there is also formed a notch 18, which defines the start of an intended tear line extending around the circumference. When the gripping tab 17 is gripped and pulled away around the circumference of the paper cone, the upper part of the paper cone, that is to say the part extending above the notch 18, can be ripped off from the lower part.

In principle it should also be mentioned that, in the case of a packaging material of (overprint) surface-coating/color/aluminum/paper, the laser marking can also be carried out on the color side in order, by that means, to modify the color or to add additional “printing” produced by laser marking. Preferably, however, it is the paper side, which is usually free from conventional printing inks, that is laser-marked.

All features disclosed in the application documents are claimed as being important to the invention insofar as they are novel on their own or in combination compared with the prior art.

### REFERENCE NUMERALS

10 aluminum layer
11 paper layer
12 paper layer
13 paper cone
14 packaging material portion of paper cone 13
16 longitudinal edges
17 gripping tab
18 notch

What is claimed is:

1. A multi-layer packaging material, comprising:
at least one metal barrier layer; and
at least one paper layer, wherein the paper layer is laser-marked with predetermined intensity at least portion-wise through its entire cross-section.

2. The multi-layer packaging material according to claim 1, wherein the packaging material is a laminate.

3. The multi-layer packaging material according to claim 1, wherein the packaging material is suitable for packaging a material selected from the group consisting of food, hygiene products and electronic products.

4. The multi-layer packaging material according to claim 1, wherein the metal barrier layer comprises especially aluminum

5. The multi-layer packaging material according to claim 1, wherein the paper layer is also laser-marked with predetermined intensity at least portion-wise through the metal barrier layer on its surface side.

6. The multi-layer packaging material according to claim 1, wherein the paper of the paper layer has a weight of about 50 to 140 g/m².

7. The multi-layer packaging material according to claim 1, wherein the paper layer and/or metal layer is/are laser-marked in an atmospheric environment by either a CO₂, solid-state laser having an energy density in the range from about 0.3 mJ/cm² to about 50 J/cm², or by a pulsed laser having a pulse frequency in the range from 0.1 to 10000 Hz, and a pulse length in the range from 0.1 to 1000 ns, especially 1 to 100 ns.

8. The multi-layer packaging material according to claim 7, wherein the laser is a YAG, laser

9. The multi-layer packaging material according to claim 7, wherein the laser is a CO₂, solid-state laser, and the energy density is in the range from about 0.5 mJ/cm² to about 15 J/cm²,

10. The multi-layer packaging material according to claim 7, wherein the laser is a pulsed laser and the pulse frequency is in the range from 1 to 1000 Hz

11. The multi-layer packaging material according to claim 7, wherein the laser is a pulsed laser and the pulse length is in the range from 1 to 100 ns.

12. The multi-layer packaging material according to claim 1, wherein the packaging material has a layer sequence selected from the group consisting of:
a) oriented polypropylene (OPP)/color/aluminum/paper;
b) polyethylene terephthalate (PET)/color/aluminum/paper;
c) oriented polypropylene (OPP)/paper/aluminum/paper;
d) surface-coating/color/aluminum/paper;
e) paper/aluminum/paper; and
f) paper/aluminum.

13. The multi-layer packaging material according to claim 1, wherein the paper layer contains amounts of micronized and/or fibrous plastic(s), in an amount in the range between about 0.001 and 15% by weight, based on the weight of the paper

14. The multi-layer packaging material according to claim 13, wherein the micronized and/or fibrous plastic(s) comprise linear aromatic polyesters and/or linear polyarylenes.

15. The multi-layer packaging material according to claim 13, wherein the paper further comprises colored, light-sensitive pigments.

16. The multi-layer packaging material according to claim 15, wherein the micronized and/or fibrous plastic(s) and the pigments are each present in an amount in the range between about 0.008 and 5.3% by weight.

17. The multi-layer packaging material according to claim 16, wherein the micronized and/or fibrous plastic(s) and the pigments are each present in an amount in the range between about 0.05 and 0.09% by weight.

18. A method of producing a packaging unit, comprising obtaining the multi-layer packaging material according to claim 1 and forming the material into a packaging unit, wherein the inside and/or outside of the packaging unit is laser-marked.

19. The method of claim 18, wherein the packaging unit is for holding food.

20. The method of claim 19, wherein the packaging unit is a paper cone for holding an ice-cream cone.

21. A paper cone, comprising the multi-layer packaging material according to claim 1, wherein the material is shaped into a cone.

22. A roll material suitable for producing a paper cone for holding ice-cream cones, comprising the multi-layer packaging material according to claim 1, wherein the material is rolled to form a roll.
